(19) United States
(12) Patent Application Publication
(10) Pub. No.: US 2008/0165363 A1
(43) Pub. Date: Jul. 10, 2008

(54) FLASH PHOTOLYSIS SYSTEM

(76) Inventor: Alex Gusev, Sarasota, FL (US)

Correspondence Address: FRASER CLEMENS MARTIN & MILLER LLC, 28366 KENSINGTON LANE, PERRYSBURG, OH, 43551, US

(21) Appl. No.: 11/970,676

(22) Filed: Jan. 8, 2008

Related U.S. Application Data
(60) Provisional application No. 60/884,026, filed on Jan. 9, 2007.

(51) Int. Cl. G01N 21/00

(52) U.S. Cl. 356/436

(57) ABSTRACT

A spectrometer capable of flash photolysis useful in the study of chemistry is disclosed, the spectrometer comprises a compartment for receiving a chemical sample; a first light source; a collective objective lens for directing light radiation emitted from the first light source through the chemical sample in the compartment; a second light source for directing a short flash pulse of light radiation into the chemical sample in the compartment; and a means for measuring the change in absorption having an input for receiving the light radiation emitted from the chemical sample in the compartment.

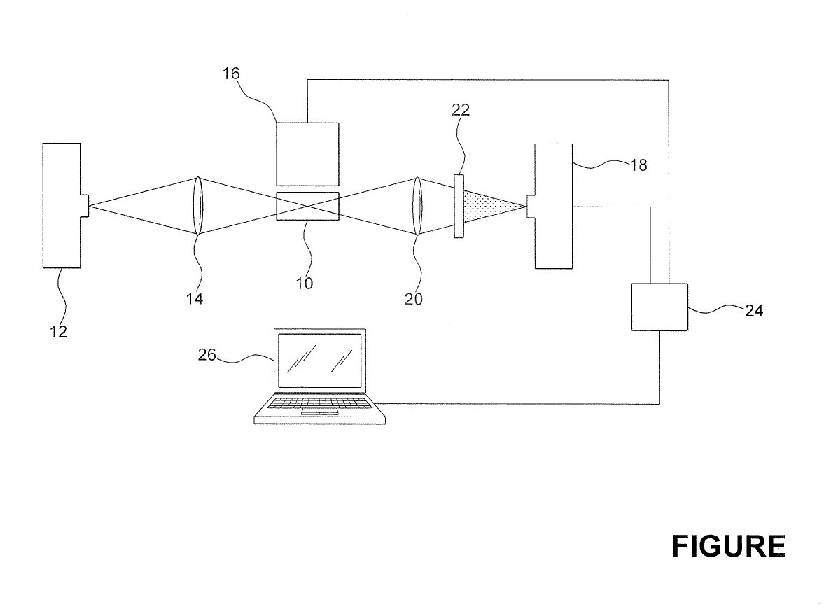

### CROSS-REFERENCE TO RELATED APPLICATION

This application claims the benefit of U.S. provisional patent application Ser. No. 60/884,026 filed Jan. 9, 2007.

### BACKGROUND OF THE INVENTION

1. Field of the Invention

The present invention relates to spectroscopy and more specifically, to a spectrometer capable of flash photolysis useful in the study of chemistry.

2. Description of the Prior Art

In the study of chemistry, students utilize spectrometers for studying the make-up of materials using the Laser Flash Photolysis (LFP) method. LFP spectrometers typically include a powerful laser to effect the breakdown of materials being tested. Such lasers are bulky and expensive. LFP is a technique utilized to study reaction mechanisms in chemical and biological processes. The technique was introduced in 1966 by Lindqvist at the CNRS in France and the technique was quickly developed by various research groups around the world. LFP was brought about by the invention of the laser, in the early 1960s. The technique of LFP consists of a pulsed laser source that generates a chemical species in a sample to be studied, an optical and electronic system capable of sensing optical changes in a sample, and a computer suitably equipped to selectively capture, process, and display the data. The optical and electronic systems constitute a fast spectrometer capable of acquiring spectra of short-lived chemical species called “intermediates”. The optical and electronic systems then record the evolution of the intermediates over time. The time resolution in such fast spectrometer can be achieved by two primary methods.

A first method includes use of fast electronics where a readout of a fast detector is digitized and recorded in real time, or when an electronic gating is applied to the detector. The electronic gating is typically used with array-based spectrometers where the output cannot be processed rapidly enough to perform real time data acquisition. Both techniques typically utilize continuous wave (CW) or pulsed xenon arc lamps as a probe light source. Due to the low intrinsic brightness and poor collimation of a probe beam produced by the probe light source, an optical overlap between the probe and a pump (excitation) beam takes place over an area of approximately 1 cm², thereby placing energy requirements on the laser pulse necessary to induce chemical changes in the sample. The corresponding pump laser pulses typically have energy of a few millijoules. Because of the pulse energy requirement, only a limited number of lasers, known as Q-switched lasers, can be used with the xenon arc lamp probe light source to produce the required energy. Systems including such lasers are bulky and expensive.

A second method is called optical gating or the “pump-probe” method. In this method, the dynamics of a chemical change of a sample is monitored by studying a series of light pulses from a laser at different times as the light pulses (pump beam) are passed through the sample. The probe and pump (excitation) beams travel trough the same volume of the sample studied, meaning the pump beam and the probe beam are spatially overlapped in the sample. The pump laser pulse induces a transient chemical change in the sample which affects the optical properties of the sample. A spectrum of the probe pulse passing through the sample is altered by the changes made to the sample by the pump beam and depending on when the probe pulse arrives to the sample with respect to the pump pulse. Systems utilizing the pump-probe typically include lasers that are bulky and expensive.

It would be desirable to produce an inexpensive and less bulky instrument to use in teaching the basic principles of the flash photolysis technique through the utilization of inexpensive light sources.

### SUMMARY OF THE INVENTION

It has surprisingly been discovered that the above objectives can be achieved by a spectrometer system manifesting the basic principles of flash photolysis.

In one embodiment the system for flash photolysis comprises a radiation transparent compartment for receiving a chemical sample to be analyzed; a first source of light radiation; optical means for channeling light from the first source through a chemical sample in the compartment; a second source of light radiation for directing short flash pulses of light radiation into the chemical sample in the compartment to initiate a chemical change in the sample; and means for measuring the change in absorption of the light radiation by the sample during the chemical changes in absorption of the light radiation by the sample during the chemical changes.

In another embodiment, the system for flash photolysis comprises a radiation transparent compartment for receiving a chemical sample to be analyzed; a first source of light radiation; optical means for channeling light from the first source through a chemical sample in the compartment; a second source of light radiation for directing short flash pulses of light radiation into the chemical sample in the compartment to initiate a chemical change in the sample; a second optical means for channeling light; and means for measuring the change in absorption of the light radiation by the sample during the chemical changes in absorption of the light radiation by the sample during the chemical changes, wherein said second optical means for channeling light directions the short flash pulses of light radiation caused to pass through the chemical sample to the means for measuring the change in absorption of the light radiation by the sample during the chemical changes in absorption of the light radiation by the sample during the chemical changes.

In another embodiment, A flash photolysis system comprises a transparent compartment for receiving a chemical sample to be analyzed; a probe light source including a light emitting diode and a collective objective lens for directing light radiation emitted from the diode along a path through the chemical sample in the transparent compartment; an excitation light source for directing short flash pulses of light radiation into the chemical sample in the transparent compartment; a photodetector having an input for receiving the light radiation emitted from the chemical sample in the transparent compartment and an output for transmitting a signal corresponding to changes in the light radiation received by the input; a collective objective lens for directing the light radiation passing through the excited chemical sample to the photodetector; a data acquisition device having an input coupled to the output of the photodetector for digitizing the signal received from the photodetector and an output; and a microprocessor having an input coupled to the output of the data acquisition device for processing the received signal for study.

### BRIEF DESCRIPTION OF THE DRAWING

The above objects and advantages of the invention will become readily apparent to those skilled in the art from reading the following description of a preferred embodiment when considered in the light of the accompanying drawing which is a schematic layout of an educational grade flash photolysis spectrometer incorporating the features of the present invention.

### DETAILED DESCRIPTION OF THE PREFERRED EMBODIMENT OF THE INVENTION

Referring to the drawing, there is illustrated an educational grade flash photolysis spectrometer which includes a compartment 10 for retaining a sample of a chemical to be analyzed. More specifically, a cuvette for retaining the chemical sample to be investigated is disposed within the compartment 10. The cuvette is typically 2 cm. in length and is transparent to the radiation used to excite the chemicals being investigated.

A first light source 12 is disposed to emit a probe source of white light electromagnetic radiation along a path through compartment 10 and the chemical being investigated. The white light radiation produced by the first light source 12 is caused to travel through the chemical sample holding cuvette by passing the radiation through a collective objective lens 14 disposed therebetween. It is understood that the first light source 12 may be any commercially available light source such as a light emitting diode (LED) or a Xe flash lamp, for example.

A second source of light radiation 16 is an excitation light source disposed to direct a short flash pulse of light radiation into the chemical sample in the compartment 10 for excitation of the chemical sample. The second source of light radiation 16 is typically capable of producing short flash pulses of light radiation, down to 1/64,000 seconds, for example. It is understood that the second source of light radiation 16 may be any commercially available source of excitation light capable of producing short flash pulses, such as a photographic flash, for example.

The white light radiation from the first light source 12 is utilized for probing the spectral changes which take place after the sample has been exposed to excitation flash pulses of radiation from the second source of light radiation 16. The transient white light radiation produced by the first light source 12 is caused to be sent through the sample in the compartment 10 by the lens 14 and subsequently delivered to the input of a means for measuring the change in absorption 18 of the light radiation by the sample by passing through a collective objective lens 20 and an optical interference filter 22. The means for measuring the change in absorption 18 includes an output adapted transmit a signal. It is understood that the means for measuring the change in absorption 18 may be any conventional photodector such as a photodiode, for example.

The optical interference filter 22 is effective to select the desired wavelength out of the broad emission spectrum of the radiation produced by the first light source 12 to be passed to the means for measuring the change in absorption 18. While the continuous wave (CW) output from the first light source 12 is maintained by the means for measuring the change in absorption 18, the photoexcitation flash from the second source of light radiation 16 is sent through the sample. The resultant photo induced transient species cause the absorption of the sample to deviate from the level before the excitation flash of radiation from the second source of light radiation 16. Accordingly, the intensity of the light radiation from the first source of light 12 passing through the sample changes in intensity. The changes are detected by the means for measuring the change in absorption 18. Voltage waveform information is sent from the output of the means for measuring the change in absorption 18 to a data acquisition device 24 for collection and digitizing. The information is thence sent from the data acquisition device 24 to an input of a microprocessor 26, such as a computer, for storage or further manipulation.

It is to be understood that the above description is not meant to limit the scope of the present invention. Many combinations of commercially available components can be used to assemble the aforedescribed system. However, it has been discovered that the following selection of components works well in combination with each other to achieve the objectives of the invention. Amongst the objectives achieved are the following: allows for the miniaturization and portability desired; and offers a cost effective solution.

The following key components are deemed to be effective in achieving the desired objectives:
12—White light LED—Lumileds Luxeon Portable Star V LED (LXHL-LWGC)
14, 20—Lenses and opto-mechanics LA1131-A THOR LABS
16—Photographic Flash; SB 600 Speedlite Photo Flash (SB 600), Nikon
18—Photodetector; Silicon detector (PDA36A) THOR LABS
22—Interference filter; F10-560.0-4-1.00 CVI
24—Data Acquisition Device: N1 USB-6210 BUS-POWERED M Series DAQ National Instruments, Inc.

It is expected that numerous variants will be obvious to those skilled in the field of analytical chemistry without any departure from the spirit of the invention. The appended claims, properly construed, form the only limitation upon the scope of the invention.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A system for flash photolysis comprising:
a radiation transparent compartment for receiving a chemical sample to be analyzed;
a first source of light radiation;
optical means for channeling light from the first source through a chemical sample in the compartment;
a second source of light radiation for directing short flash pulses of light radiation into the chemical sample in the compartment to initiate a chemical change in the sample; and
means for measuring the change in absorption of the light radiation by the sample during the chemical changes in absorption of the light radiation by the sample during the chemical changes.

2. The system of claim 1, wherein said first source of light radiation is a Xe flash lamp.

3. The system of claim 1, wherein said first source of light radiation is a light emitting diode.

4. The system of claim 1, wherein said optical means for channeling light is a collective objective lens.

5. The system of claim 1, wherein said means for measuring the change in absorption of the light radiation is a photodiode.

6. The system of claim 1, wherein said second source of light radiation is a photographic flash.

7. The system of claim 1, further including an optical interference filter adapted to select a desired wavelength of radiation from the first source of radiation.

8. The system of claim 1, further including a second optical means for channeling light for directing the short flash pulses of light radiation caused to pass through the chemical sample to the means for measuring the change in absorption of the light radiation by the sample during the chemical changes in absorption of the light radiation by the sample during the chemical changes.

9. The system of claim 8, wherein the second optical means for channel light is a collective objective lens.

10. The system of claim 1, further including a data acquisition device adapted to collect and digitize information from an output signal from said means for measuring the change in absorption of the light radiation.

11. The system of claim 10, further including a microprocessor adapted to receive the digitized information from said data acquisition device for one of at least storage and further manipulation.

12. A system for flash photolysis comprising:
a radiation transparent compartment for receiving a chemical sample to be analyzed;
a first source of light radiation;
optical means for channeling light from the first source through a chemical sample in the compartment;
a second source of light radiation for directing short flash pulses of light radiation into the chemical sample in the compartment to initiate a chemical change in the sample;
a second optical means for channeling light; and
means for measuring the change in absorption of the light radiation by the sample during the chemical changes in absorption of the light radiation by the sample during the chemical changes, wherein said second optical means for channeling light directions the short flash pulses of light radiation caused to pass through the chemical sample to the means for measuring the change in absorption of the light radiation by the sample during the chemical changes in absorption of the light radiation by the sample during the chemical changes.

13. The system of claim 12, wherein said first source of light radiation is one of a Xe flash lamp and a light emitting diode.

14. The system of claim 12, wherein at least one of said optical means for channeling light and said second optical means is a collective objective lens.

15. The system of claim 12, wherein said means for measuring the change in absorption of the light radiation is a photodiode.

16. The system of claim 12, wherein said second source of light radiation is a photographic flash.

17. The system of claim 12, further including an optical interference filter adapted to select a desired wavelength of radiation from the first source of radiation.

18. The system of claim 12, further including a data acquisition device adapted to collect and digitize information related to an output voltage from said means for measuring the change in absorption of the light radiation.

19. The system of claim 12, further including a microprocessor adapted to receive the digitized information from said data acquisition device for one of at least storage and further manipulation.

20. A flash photolysis system comprising:
a transparent compartment for receiving a chemical sample to be analyzed;
a probe light source including a light emitting diode and a collective objective lens for directing light radiation emitted from the diode along a path through the chemical sample in the transparent compartment;
an excitation light source for directing short flash pulses of light radiation into the chemical sample in the transparent compartment;
a photodetector having an input for receiving the light radiation emitted from the chemical sample in the transparent compartment and an output for transmitting a signal corresponding to changes in the light radiation received by the input;
a collective objective lens for directing the light radiation passing through the excited chemical sample to the photodetector;
a data acquisition device having an input coupled to the output of the photodetector for digitizing the signal received from the photodetector and an output; and
a microprocessor having an input coupled to the output of the data acquisition device for processing the received signal for study.
